(19) United States
(12) Patent Application Publication
(10) Pub. No.: US 2012/0270498 A1
(43) Pub. Date: Oct. 25, 2012

(54) METHOD FOR SAVING RESOURCES AND ENERGY IN MOBILE TERMINALS

(76) Inventor: Michael Kurz, Wien (AT)

(21) Appl. No.: 13/518,260

(22) PCT Filed: Jan. 13, 2011
(86) PCT No.: PCT/EP11/00114

§ 371 Date: Jun. 21, 2012

(30) Foreign Application Priority Data
Jan. 14, 2010 (DE) 10 2010 004 748.1

(51) Int. Cl. H04W 52/02; H04B 5/00

(52) U.S. Cl. 455/41.1

(57) ABSTRACT

The invention relates to a method for establishing and maintaining a mobile radio connection between a base station (1) of a mobile radio communication network and a mobile radio communication terminal. A mobile radio connection (7) between the base station (1) of the mobile radio communication network and a first mobile radio communication terminal serving as a master (3) is established and maintained. Additionally, between the first terminal serving as a master (3) and at least one second mobile radio communication terminal serving as a client (4, 5), a near field radio ME communication link (8) is established and maintained for data transmission between master (3) and client (4).

The invention relates to a method for establishing and maintaining a mobile radio communication link between a base station of a mobile radio communication network and a mobile radio communication terminal.

The performance of mobile radio networks and the corresponding mobile terminals (ME) is increasing steadily with respect to the data rate and multimedia functions, as well as the integrated displays with high resolution. In spite of, for example, energy-efficient modulation methods, electricity-saving displays, etc., the power consumption is increasing almost directly proportional. Specifically in the case of radio transmission systems which work according to the principle of “always on” (always ready for use, i.e. always turned on), the increasing power consumption cannot be completely compensated by more capacitive batteries, or electricity-saving electronics in mobile terminals.

Thus, the lowered operating time due to the higher power consumption and the requirement that the batteries of mobile terminals must be charged frequently, is disadvantageous.

Therefore, the object of the invention is to propose a method for saving resources and energy in mobile terminals which on the one hand, makes a very high rate of data transmission and extensive multimedia functions possible, and on the other hand, lowers the energy requirements during operation of the mobile terminal, in order to increase the operating time of the mobile terminals.

In accordance with the invention, this problem is solved by a method according to claim 1. Advantageous further developments of the method in accordance with the invention are given by the subordinate claims.

It is proposed a method for establishing and maintaining a mobile radio communication link between a base station of a mobile radio communication network and a mobile terminal wherein a mobile communication connection is established and maintained between the base station of the mobile communication network and a first mobile radio communication terminal that serves as master, and wherein between the first terminal serving as master and at least one second mobile radio communication terminal serving as client, a near-field communication link is established and maintained for data transmission between master and client.

Thereby, within the scope of this application, the terms mobile terminal and mobile radio communication terminal are to be understood as synonymous, i.e. that the term mobile radio communication terminal comprises any form of a mobile terminal, which is suitable for establishing and maintaining a mobile radio communication link with a base station of a mobile radio communication network.

It is thus the key aspect of the method in accordance with the invention that by means of additional, low-energy radio transmissions in the near-field, the otherwise individual radio connections between mobile terminals to the mobile radio communication network are allocated and administered energy-efficiently by means of a master-client architecture.

The controlling and the routing of the data from and/or to the base station of the mobile radio communication network and/or from and/or to the clients is preferably executed by means of the mobile radio communication terminal serving as master.

In a preferred embodiment, several near-field communication connections from the master are established and maintained parallel to a number of clients.

Alternatively or cumulatively, near-field communication links can be established and maintained among several clients. It is thus possible, to realize and establish the connections between master and client in a 1:N mode or also in an N:N mode.

Near-field radio communication links are preferably radio communication links according to the NFC standard, RFID, Bluetooth, W-LAN, IRDA or the like.

Thus, for the establishment and maintenance of the near-field communication link between master and client, a near-field communication standard can be used that allows a radio transmission in the near-field at low power consumption, in order to thus significantly increase the operating time of the mobile terminal even during an established radio communication link in contrast to a mobile radio communication link to a base station of a mobile communication network.

The method in accordance with the invention can be designed in such a way that several levels are operated in which a client of a higher level simultaneously serves as master of the next lower level with one or several additional clients. Hereby, it is possible to introduce several priority levels and to operate such depending on demand.

Preferably, terminals of this type that currently and/or after the elapse of a specifiable period of time without data transmission, are not in a radio transmission mode, are switched to a stand-by mode. Thus, terminals that are used as clients and/or such terminals that are used as masters of a lower level can be put into stand-by mode if currently and/or during a specifiable period of time, no data transmission occurs/occurred.

When a mobile terminal was switched to idle mode, it can, for example, be woken up by sending a corresponding signal from the master to the client and, depending on the configuration, be put into conventional mobile communication mode and/or into the low-energy communication mode.

Alternatively or cumulatively, the mobile terminal that is in idle mode can also be woken up by the user of the device by means of the push of a button or by touching the device, which due to capacitive, resistive, thermal sensors, sensors for lumen measurements or comparable methods or sensor systems detects that the device is being touched and hereby, the device is woken up from idle mode and, depending on the configuration, put into is conventional mobile communication mode or into the low-energy near-field communication mode.

Alternatively or cumulatively, it is also possible to equip the device with gyro sensors, acceleration sensors or the like in order to detect when the user moves or shakes the terminal in order to thus put the device out of idle mode and into operating mode and, depending on the configuration, to switch into conventional mobile communication mode or into the low-energy communication mode.

In the following, the invention will be explained in more detail in conjunction with the figures. Shown are:

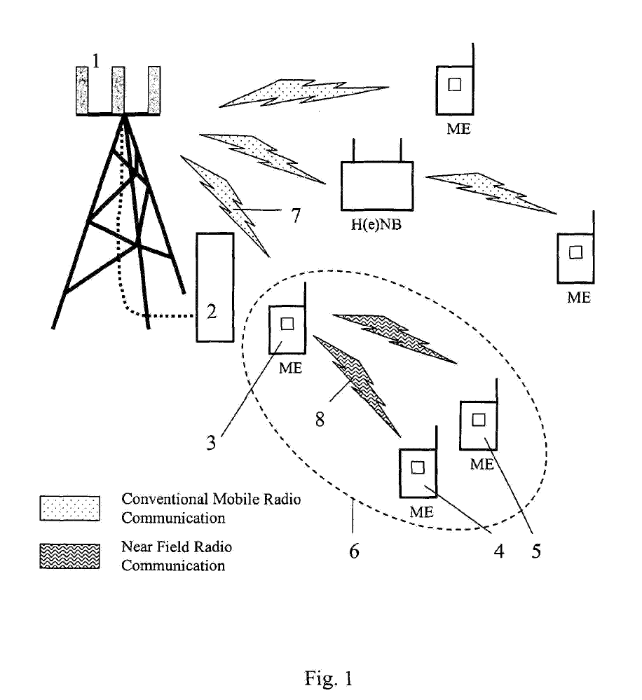

FIG. 1: a schematic illustration of the radio communication links between mobile terminals with the mobile communication network and an additional energy-efficient near-field radio communication link in master-client architecture;

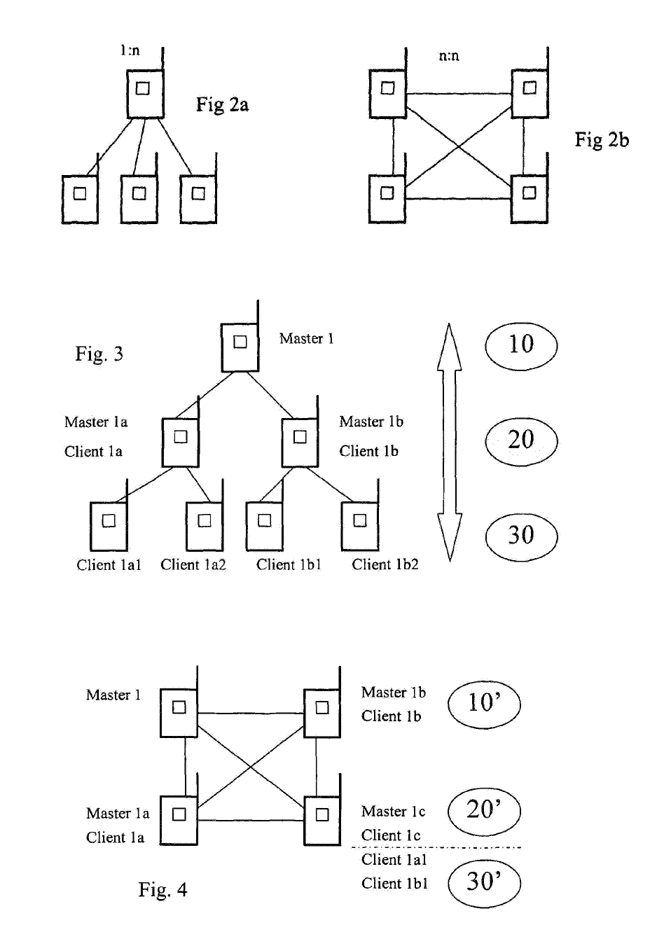

FIG. 2: an alternative configuration of the connection between master and clients;

FIG. 3: several prioritization levels in a first configuration;

FIG. 4: several prioritization levels in a second configuration;

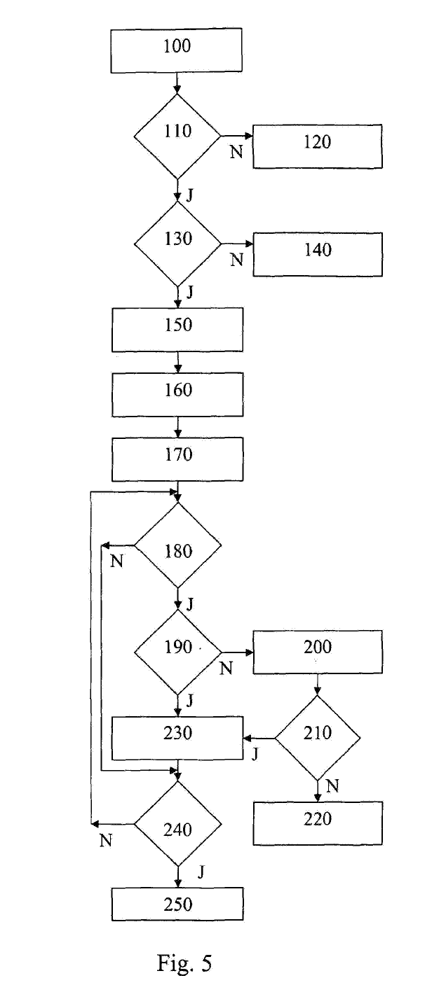

FIG. 5: a flow diagram during operation of a near-field radio communication link between master and client;

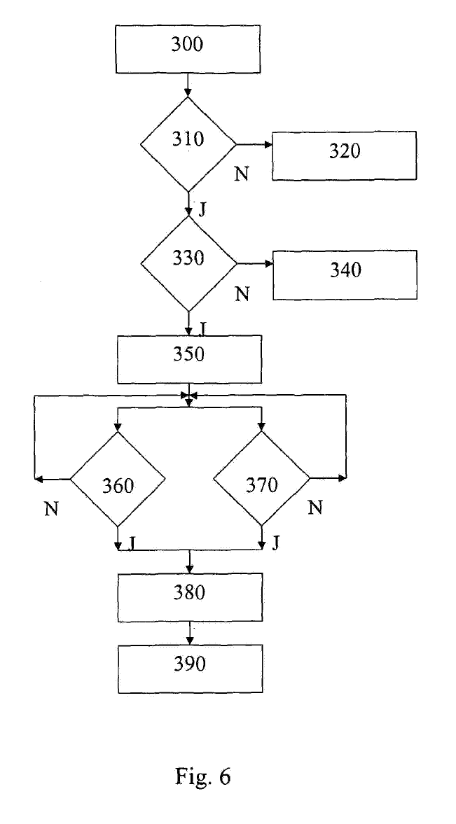

FIG. 6: a flow diagram of the switching from idle mode into operating mode and the establishment of a near-field radio communication link.

FIG. 1 illustrates a schematic of the radio links between mobile communication terminals ME and a base station 1 of a mobile radio communication network. The base station 1 of the mobile radio communication network has a corresponding unit 2 containing the control logic of the mobile radio communication network.

Between the transmitting base station 1 of the mobile radio communication network and the various mobile terminals ME, conventional mobile radio communication links are established, as they are shown by arrows 7 with dots.

A certain mobile communication device ME, which is connected with the base station 1 by a conventional mobile communication link 7, is thereby operated as master 3. Between master 3 and clients 4, 5, which are likewise ordinary mobile communication terminals ME, a near-field radio communication link 8 is established, as it is indicated by arrows 8 with wavy lines. Thus, an interconnection 6 of various mobile radio communication terminals 3, 4, 5 is established as a low-energy radio connection, whereby one of the mobile communication terminals, terminal 3 is configured as master and two additional mobile communication terminals 4, 5 as clients, as shown in the example illustrated in FIG. 1.

The method according to the invention that is shown schematically in FIG. 1 thus provides an additional radio transmission via a near-field radio link 8 such as NFC or RFID, Bluetooth, W-LAN, IRDA or similar, which due to the smaller transmitting power required, save significantly more energy, than a normal mobile radio connection link 7 such as it is established and maintained between the master 3 and the mobile radio base station 1. Instead of sending and maintaining the signals between base station 1 of the mobile radio communication network to the individual mobile terminals 4, 5 and vice versa, by means of the mobile radio technology, such as, for example, GSM, UMTS, LTE, etc., that is made available by the mobile radio communication network, a device is declared to be master 3, which administers the communication with one or several clients 4, 5. This master 3 takes over not only the complete communication with the mobile communication network 1, but also the controlling and the routing of data from the mobile radio communication network 1 to the clients 4, 5 or from the clients 4, 5 to the network 1, as long as the clients 4, 5 are located in the near-field radio transmission mode, i.e. in range 6.

As shown in FIGS. 2a and 2b, the connections between master and client can thereby be realized in 1:N mode (FIG. 2a) or also in N:N mode (FIG. 2b). A configuration of the connections according to FIG. 2a in 1:N mode is advantageously suitable if there are many devices that are in stand-by mode (idle mode).

A configuration of the connections in N:N mode according to FIG. 2b is advantageously suitable when data transfer is low.

As shown in FIGS. 3 and 4, several prioritization levels, 10, 10′; 20, 20′; 30, 30′ can be set up and operated, as this is shown, for example, in FIGS. 3 and 4 for various connection modes.

In FIG. 3, the mobile radio terminal serving as master 1a is simultaneously labeled as client 1a. Hereby, it is to be made clear that by means of the routing in the near-field communication network, for example, the master 1a from the point of view of master 1, is actually a client (client 1 a). From the point of view of client 1a1 and/or client 1a2 of prioritization level 30, it is, however, their master with the label master 1a, etc.

Thus, prioritization levels 10, 20, 30 are formed, whereby the clients of the prioritization level 20 simultaneously form respectively one master of prioritization level 30. The priority of the routed data to or from the mobile communication network in the near-field communication network is thus given, for example, with high priority of prioritization level 10, with medium priority of prioritization level 20, and with low priority of prioritization level 30.

An alternative mode of operation is shown in FIG. 4, whereby here too, three prioritization levels 10′, 20′, 30′ are established and operated. Thereby, in FIG. 4, for example, master 1c is simultaneously client 1c, client 1a1 is client 1 b1, etc., as the mobile communication terminals are configured to an N:N matrix among themselves according to the illustration in FIG. 4. The priority changes according to the respective configuration and the resulting routing between medium and low, etc. The configuration for the routing according to FIG. 4 is thus more complex than in the prioritization according to FIG. 3.

For example, if a communication takes place, due to a corresponding configuration, directly between master 1 and master 1c, which—from the point of view of master 1 is actually a client 1c, the data are routed with medium priority. But if, for example, due to another configuration, a communication between client 1a1 via master 1b to master 1 is established, the data are routed with low priority, as no direct connection with medium priority is switched, but only an indirect connection of low priority is operating via a switch.

The connections between master and client can thus be executed, as shown, in a 1:N mode or also in an N:N mode. In the case of particularly large data volume, or when there are requirements of an especially low delay, switching can however also be done dynamically in the mobile terminals into the conventional mobile radio operating mode and, if necessary, back into the energy-saving near-field communication mode.

The mobile terminals which are configured as client or as master of a subordinate prioritization level can be put into a stand-by operation mode or into idle mode. In the following, this mode is called idle mode. As the mobile terminals are in idle mode most of the time, this is to be used advantageously in the method according to the invention as well. For switching into the operating mode, a corresponding signal can be sent by the master to the clients when the master receives a corresponding paging (broadcast) from the mobile radio communication network. The mobile terminal is woken up from the idle mode and, depending on the configuration, it is switched to the conventional mobile communication mode or into the low-energy near-field communication mode.

Alternatively or cumulatively, it is also possible that the user touches the mobile terminal, which, by means of capacitive, resistive or thermal sensors or measurements of lumen or comparable sensors, detects the touch by the user and wakes the device from the idle mode and, depending on configuration, puts it into the conventional mobile communication mode or into the low-energy near-field communication mode.

Alternatively or cumulatively, it is also possible that the user moves or shakes the mobile terminal, which recognizes and detects this movement or shaking by means of, for example, gyro sensors, acceleration sensors or the like, and wakes the device from the idle mode and, depending on the configuration, is switches it into one of the provided operating modes such as the conventional mobile communication mode or the low-energy near-field communication mode.

FIG. 5 shows a flow diagram in which a mobile communication terminal is switched into the idle mode.

At the start of the flow according to FIG. 5, in step 100, the mobile radio communication terminal is in the range of a near-field radio connection.

In the next step 110 it is first tested if the mobile communication terminal is equipped for a near-field radio communication. If not, it is switched to idle mode in step 120.

If yes, it is tested in step 130 if the near-field radio communication function is switched on in the mobile terminal, i.e. if this function is active. If not, the mobile terminal is switched to idle mode in step 140.

If yes, the configuration of the mobile communication terminal as master and/or client takes place in step 150.

The configuration of the mobile communication terminals of the prioritization levels takes place in the next step 160, as well as the routing.

Switching of the mobile communication terminal into the near-field communication mode, i.e. into the low-energy radio mode, takes place in the next step 70.

In step 180 it is being tested if a data transfer from the mobile radio communication terminal to or from the mobile radio communication network is taking place. If yes, it is tested in step 90 if the performance, i.e. the quality of the radio communication link is sufficient for the data transfer. If no, a reconfiguration of the mobile communication terminals of the prioritization level takes place in step 200, as well as the routing, and in the following step 210, a new testing takes place if now the performance for the data transfer from and to the mobile radio communication terminal is sufficient.

If not, switching of the mobile radio communication terminal into the conventional mobile radio mode for utilization of a mobile radio connection to the mobile radio network with an, if available, larger band width for the data transfer takes place in step 220.

If the previous tests in step 190, and in step 210 respectively, have indicated that the performance is sufficient for the data transfer, the corresponding data transfer of the mobile radio communication terminal to or from the mobile radio communication network takes place in step 230 by utilizing the near-field radio connection and by using an intermediate mobile radio communication terminal that serves as master.

In step 240 it is tested whether no data transfer has occurred during a defined period of time. If yes, the mobile radio communication terminal is switched into the idle mode in step 250.

In FIG. 6 in turn, the transition from idle mode into the mode of near-field radio communication is shown.

In step 300, the mobile terminal is in idle mode.

In step 310 it is tested whether the mobile radio communication terminal can be configured for idle mode. If not, the mobile radio communication terminal works in conventional mobile communication operation in step 320.

If yes, it is tested in step 330, if the mobile radio communication terminal is currently intended to be in idle mode, i.e. that the idle mode is switched on in the mobile radio is communication terminal. If not, the mobile radio communication terminal operates in normal mobile radio operation in step 340.

If yes, switching of the mobile communication terminal into idle mode is performed in step 350.

In step 360 it is tested if a corresponding signal has been sent by the master to the client and/or if in step 370 a touching or an actuation of a user has taken place at the mobile radio communication terminal. If yes, the “waking up” of the mobile radio communication terminal takes place in step 380 and in step 390, the expansion and maintenance of a near-field radio connection from the mobile terminal as client to a master takes place.

The special advantages of the method in accordance with the invention lie in the enormous potential of saving resources and energy, which results primarily due to the switching into the idle mode, as well as the utilization of near-field radio connections for data transfer, as hereby, contrary to an operation in a normal mobile radio environment, extreme energy savings result. This results in longer operating times of the mobile radio communication terminals. Mobile radio operators can, on the basis of optional statistics, optimize network planning in order to offer optimized solutions.

The method can also be used in conventional mobile radio operation (GSM, UMTS, LTE, etc.) as well as W-LAN, WIMAX etc. in order to control the functions of the mobile terminals more efficiently in terms of resources and energy.

Preferably, the data are made usable during the duration in normal mobile communication mode with and without idle mode, as well as in near-field communication mode for mobile radio operators. It is also possible to likewise use the method via an intermediate station, identified in FIG. 1 as H(e)NB (device in mobile radio communication networks, which is designed as Home NodeB (HNB) and Home eNodeB (HeNB).

1. A method for establishing and maintaining a mobile radio connection between a base station of a mobile radio communication network and a mobile radio communication terminal, the method comprising the steps of:
establishing and maintaining a mobile radio connection between the base station of the mobile radio communication network and a first mobile radio communication terminal serving as a master and
establishing and maintaining between the first terminal serving as a master and at least one second mobile radio communication terminal serving as a client, a near-field radio communication link for data transmission between master and client.

2. The method according to claim 1, further comprising the step of:
controlling and routing data from or to the base station of the mobile radio communication network or from or to the client by the mobile radio communication terminal serving as master.

3. The method according to claim 1, further comprising the step of:
establishing and maintaining near-field communication links by the master parallel to several of clients.

4. The method according to claim 1, further comprising the step of:
establishing and maintaining near-field radio communication links among several clients.

5. The method according to claim 1, wherein the near-field radio link is a radio connection according to the NFC standard, RFID, Bluetooth, WLAN or IRDA.

6. The method according to claim 1, further comprising the step of:
operating several hierarchical levels that are each assigned to at least one of the mobile radio communication terminals a client assigned to a higher level simultaneously serving as master for one or more clients of the next lower level.

7. The method according to claim 1, further comprising the step of:
switching a mobile radio communication terminal serving as a client or as a master of a lower level into a stand-by mode if currently or during a specifiable time period no data transmission occurs or has occurred.

8. The method according to claim 7, further comprising the step of:
switching a mobile radio communication terminal serving as client from stand-by mode into operating mode by a signal from master to the client and that a near-field radio communication link is established between master and client.

9. A data-processing program product with program instructions for the execution of the method according to claim 1 when executing the program on a data-processing system.
